(19) United States
(12) Patent Application Publication
(10) Pub. No.: US 2013/0146806 A1
(43) Pub. Date: Jun. 13, 2013

(54) POROUS LITHIUM PHOSPHATE METAL SALT AND METHOD FOR PREPARING THE SAME

(71) Applicants: Wen Chun CHIU, Yilan City (TW); Tung Feng LEE, Tainan City (TW); Tai Hong LIN, New Taipei City (TW)

(72) Inventors: Wen Chun CHIU, Yilan City (TW); Tung Feng LEE, Tainan City (TW); Tai Hong LIN, New Taipei City (TW)

(73) Assignee: HIROSE TECH CO., LTD., New Taipei City (TW)

(21) Appl. No.: 13/445,687

(22) Filed: Apr. 12, 2012

(30) Foreign Application Priority Data
Dec. 13, 2011 (TW) 100146059

(51) Int. Cl. H01M 4/58; H01M 4/88

(52) U.S. Cl. 252/182.1

(57) ABSTRACT

The present invention relates to a porous lithium phosphate metal salt and method for preparing the same. The method includes the following steps, which comprises: (A) providing starting materials including a phosphate-containing precursor, a lithium-containing precursor, a metal source, and a carbon source; (B) grinding the starting materials at room temperature to obtain a mixture; (C) spray-granulating the mixture to form a granular mixture; and (D) sintering the granular mixture to obtain a porous lithium phosphate metal salt, wherein the spray granulation process in the step (C) uses a spray granulation device having a plurality of spray nozzles.

### CROSS REFERENCE TO RELATED APPLICATION

This application claims the benefits of the Taiwan Patent Application Serial Number 100146059, filed on Dec. 13, 2011, the subject matter of which is incorporated herein by reference.

### BACKGROUND OF THE INVENTION

1. Field of the Invention

The present invention relates to a porous lithium phosphate metal salt and a method for preparing the same. More specifically, the present invention relates to a porous lithium phosphate metal salt prepared by using a spray granulation device having a plurality of spray nozzles. Thus, the porous lithium phosphate metal salt having a porosity of 10-80% is obtained, wherein the particle size distribution of the porous lithium phosphate metal salt is multi-Gaussian distribution. Furthermore, a mean particle diameter (D50) of the porous lithium phosphate metal salts is from 0.5 to 3 μm, and D90 of the porous lithium phosphate metal salts is 5 μm or less.

2. Description of Related Art

Currently, as the development of various portable electronic devices and the increment of need for mobile devices continue, more and more attention focuses on the techniques of energy storage and the applications of secondary batteries. Small-sized secondary batteries especially are the major power supplies for portable electronic devices such as cell phones, tablet computers, and notebooks.

Among the developed secondary batteries, the lithium secondary batteries are the most popular batteries used nowadays. The cathode material of the initial lithium secondary batteries was LiCoO₂. Then, a phosphate salt with olivine structure (e.g. LiFePO₄) was developed in 1996. Compared to LiCoO₂, LiFePO₄ has higher stability, lower cost, and higher charge/discharge cycles. Thus, LiFePO₄ has been generally used as cathode material of secondary batteries.

Furthermore, referring to past research, if the crystalline with olivine structure is reduced to nano-size, the migration distance of Li ion can be shortened so as to increase discharge capacity. However, when the electrode material is prepared by using small-sized olivine particles, a lot of adhesives are required which increases the mixing time of slurry and reduces the process efficiency.

In addition, there are many conventional methods for preparing LiFePO₄ in nano-size. For example, United States Patent Application No. 20100233540 A1 has disclosed an olivine-type lithium iron phosphate composed of secondary particles having a mean particle diameter (D50) of 5 to 100 μm. Then, at least a portion of the secondary particles are deformed and converted into primary particles having a mean particle diameter (D50) of 50 to 550 nm in the process of pressing to fabricate electrodes. However, the said method requires an additional crushing process, and the formed LiFePO₄ particles have poor uniformity.

Therefore, it is desirable to provide a simple method for preparing a porous lithium phosphate metal salt used as cathode material for lithium secondary batteries, which can not only improve conventional methods, but also reduce the process time and the cost of lithium secondary batteries.

### SUMMARY OF THE INVENTION

The object of the present invention is to provide a method for preparing a porous lithium phosphate metal salt. The porous lithium phosphate metal salt can be prepared by using a spray granulation device and a single sintering process. Without crushing processes, uniform powders of the porous lithium phosphate metal salt can be formed by controlling the number of nozzles in the spray granulation device. Such powders can be applied on current collectors in a lower thickness compared with conventional methods. Therefore, the porous lithium phosphate metal salt of the present invention can be applied to simplify the process for preparing a secondary battery, and also has many advantages such as simple processes, low cost, and high yield.

Another object of the present invention is to provide a porous lithium phosphate metal salt, which has nano, submicro, or micro grain size and can be applied to preparing electrode materials of lithium secondary batteries.

To achieve the object, the present invention provides a method for preparing a porous lithium phosphate metal salt, comprising the steps of: (A) providing starting materials, which comprise a phosphate-containing precursor, a lithium-containing precursor, a metal source, and a carbon source; (B) grinding the starting materials at room temperature to obtain a mixture; (C) spray-granulating the mixture to form a granular mixture; and (D) sintering the granular mixture to obtain a porous lithium phosphate metal salt represented by the following formula (I):

LiAₓB₁₋ₓPO₄ formula (I);
wherein x is from 0 to 1; A is a IIIA metal element selected from Al, Ga, or In, or a transition metal selected from Fe, Co, Ni, Mn, or V; and B is a IIIA metal element selected from Al, Ga, or In, or a transition metal selected from Fe, Co, Ni, Mn, or V.

In the method for preparing the porous lithium phosphate metal salt of the present invention, the porous lithium phosphate metal salt has olivine structure.

In the method for preparing the porous lithium phosphate metal salt of the present invention, the phosphate-containing precursor of the starting materials can be at least one selected from the group consisting of H₃PO₄, (NH₄)₂HPO₄, and NH₄H₂PO₄, preferably NH₄H₂PO₄.

Furthermore, in the method for preparing the porous lithium phosphate metal salt of the present invention, the lithium-containing precursor can be at least one selected from the group consisting of Li₂CO₃, LiOH, and LiCl, preferably Li₂CO₃.

In addition, in the method for preparing the porous lithium phosphate metal salt of the present invention, the metal source can be at least one selected from the group consisting of Fe source, Mn source, and Co source. Herein, the Fe source can be at least one selected from the group consisting of FeC₂O₄, Fe(NO₃)₃, Fe₂O₃, FePO₄, Fe₂(SO₄)₃, and Fe powders, preferably FeC₂O₄. Furthermore, the Mn source is at least one selected from the group consisting of MnSO₄, Mn(NO₃)₂, Mn(CH₃COO)₂, MnCO₃, MnCl₂, MnO, MnO₂, and Mn₂O₃.

In the method for preparing the porous lithium phosphate metal salt of the present invention, the carbon source can be at least one selected from the group consisting of sugar, vitamin C, citric acid, polyethylene (PE), polypropylene, benzene ring-containing polymer, and linear hydrocarbon. By adding the carbon source, the porous lithium phosphate metal salt can be coated with carbon on its surface so as to increase the conductivity of the formed porous lithium phosphate metal salt.

In the method for preparing the porous lithium phosphate metal salt of the present invention, the spray granulation process in step (C) can be performed by using a spray granulation device having a plurality of spray nozzles. The spray nozzle can have a plurality of sub-nozzles. Through improvements of the spray granulation device such as designing the spray nozzles and controlling the flow rate, air flow rate, and nozzle pressure, the granular mixture of lithium phosphate metal salt having nano, submicro, or micro grain size with uniformity can be directly obtained.

The type of the said spray nozzle in the spray granulation device can be rotary type, pressure type, two-fluid type, or combinations thereof. Preferably, the type of the spray nozzle in the spray granulation device is two-fluid type. The spray nozzle of rotary type is suitable for slurries with high concentration and high viscosity, and can make the particle size distribution centralized. Moreover, the spray nozzle of pressure type is non-fixed, and a required pressure can be obtained by pressing liquid with a pump. The spray nozzle of pressure type can be adjusted in three-dimension according to the condition of atomization. In addition, the spray nozzle of two-fluid type uses compressed air with high-speed flow to make liquid atomized. The spray nozzle of two-fluid type has two forms, which are an internal-mixing form and an external-mixing form. By mixing liquid with gas, smaller particles can be formed compared to a single-fluid type. Furthermore, the nozzle size of two-fluid type is bigger than the nozzle size of single-fluid type so as to reduce a condition of blocking. In the spray nozzle of two-fluid type, the adjustable range of flow rate is relatively wide. When the volume ratio of gas to liquid is higher, the formed particle size can be smaller.

Furthermore, the number of the spray nozzles in the said spray granulation device may be 8 to 16, preferably 10 to 14. Moreover, the flow rate of the spray granulation device is from 0.3 L/min to 1.5 L/min, preferably 0.3 L/min. In addition, the air flow rate of the spray granulation device may be from 50 to 150 m³/min, preferably 120 m³/min. Besides, the nozzle pressure of the spray granulation device may be from 2 to 8 kg/cm², preferably 8 kg/cm². When the flow rate, air flow rate, and nozzle pressure are in the ranges as described above, the powders of porous lithium phosphate metal salt (D50=0.5−3 μm; D90≦5 μm) can be formed. However, when the flow rate, air flow rate, and nozzle pressure are out of the ranges as described above, in addition to poor granulation efficiency, D90 of the porous lithium phosphate metal salt would be above 5 μm, and the particle size of the porous lithium phosphate metal salt can not be controlled. If the particle size is too big, the processability of the powders is decreased during coating processes. Therefore, in step (C), the granular mixture of lithium phosphate metal salt having nano, submicro, or micro grain size can be obtained with multi-Gaussian distribution by controlling suitable conditions. In addition, the temperature of hot air introduced into the spray granulation device can be from 180 to 240° C., preferably 230° C. The outlet temperature of the spray granulation device can be from 90 to 120° C., preferably 110° C.

In the method for preparing the porous lithium phosphate metal salt of the present invention, in step (D), the said granular mixture can be sintered under an N₂ atmosphere. The sinter temperature can be at 650 to 850° C., preferably 700° C., and the sinter time can be 3 to 10 hrs, preferably 8 hrs. After sintering, the granular mixture can be further converted into a porous lithium phosphate metal salt. Herein, the porous structure of the lithium phosphate metal salt can increase the porosity and decrease the migration distance of Li ion so as to increase the charge/discharge rate.

Finally, the porous lithium phosphate metal salt formed by the method of the present invention can be packaged for sale and applied to subsequent processes.

The present invention also provides a porous lithium phosphate metal salt in a granular shape, which is a composition represented by the following formula (I):

LiAₓB₁₋ₓPO₄ formula (I)
wherein x is from 0 to 1; A is a IIIA metal element selected from Al, Ga, or In, or a transition metal selected from Fe, Co, Ni, Mn, or V; and B is a IIIA metal element selected from Al, Ga, or In, or a transition metal selected from Fe, Co, Ni, Mn, or V. The porous lithium phosphate metal salt is prepared by the method as described above.

In the present invention, the mean particle diameter (D50) of the porous lithium phosphate metal salts can be from 0.5 to 3 μm, and D90 of the porous lithium phosphates metal salts can be 5 μm or less. Additionally, the particle size distribution of the porous lithium phosphate metal salt can be multi-Gaussian distribution.

In addition, in the present invention, the pore of the porous lithium phosphate metal salt of the present invention can be closed or opened, and the pore size can be from 0.2 to 1 μm.

Additionally, in the present invention, the porosity of the porous lithium phosphate metal salt can be from 10 to 80%. The porous lithium phosphate metal salt has a high porosity, thus allowing lithium ions to freely insert/extricate in structures so as to increase the insert/extricate rate to improve the charge/discharge cycles.

The present invention provides a porous lithium phosphate metal salt which can be prepared by using a spray granulation process and a single sintering process. An electrode material of porous lithium phosphate metal salt can be formed by controlling the number of nozzles, flow rate, and nozzle pressure in the spray granulation device. In addition, the porous lithium phosphate metal salt of the present invention has many advantages such as high charge/discharge cycle efficiency, excellent uniformity of particle size, and high porosity in particles which can increase the insert/extricate rate of Li ion. Furthermore, the present invention can shorten time and save cost due to such a simple process.

Other objects, advantages, and novel features of the invention will become more apparent from the following detailed description when taken in conjunction with the accompanying drawings.

### BRIEF DESCRIPTION OF THE DRAWINGS

FIG. 1 is a scheme of illustrating a method of the present invention;

FIG. 2 is an SEM photo of a porous lithium phosphate metal salt of the present invention;

FIG. 3 is a schematic diagram of a spray nozzle of a spray granulation device according to the present invention;

FIG. 4 is a multi-Gaussian distribution diagram of the particle size of LiFePO₄ according to Embodiment 1 of the present invention;

FIG. 5 is a multi-Gaussian distribution diagram of the particle size of LiMnPO₄ according to Embodiment 2 of the present invention;

FIG. 6 is a multi-Gaussian distribution diagram of the particle size of LiFe_{0.5}Mn_{0.5}PO₄ according to Embodiment 3 of the present invention;

FIG. 7 is a multi-Gaussian distribution diagram of the particle size of LiFePO₄ according to Comparative Example 1 of the present invention;

FIG. 8 is a multi-Gaussian distribution diagram of the particle size of LiMnPO₄ according to Comparative Example 2 of the present invention.

### DETAILED DESCRIPTION OF THE PREFERRED EMBODIMENT

Herein below, the present invention will be described in detail with reference to the embodiments. The present invention may, however, be embodied in many different forms and should not be construed as being limited to the embodiments set forth herein. Rather, these embodiments are provided to fully convey the concept of the invention to those skilled in the art.

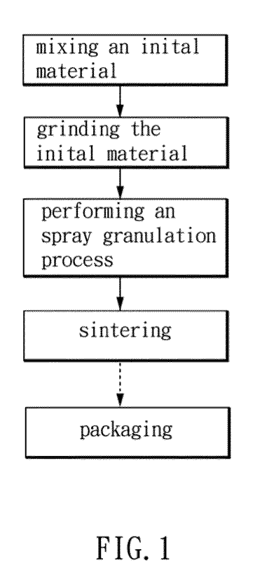

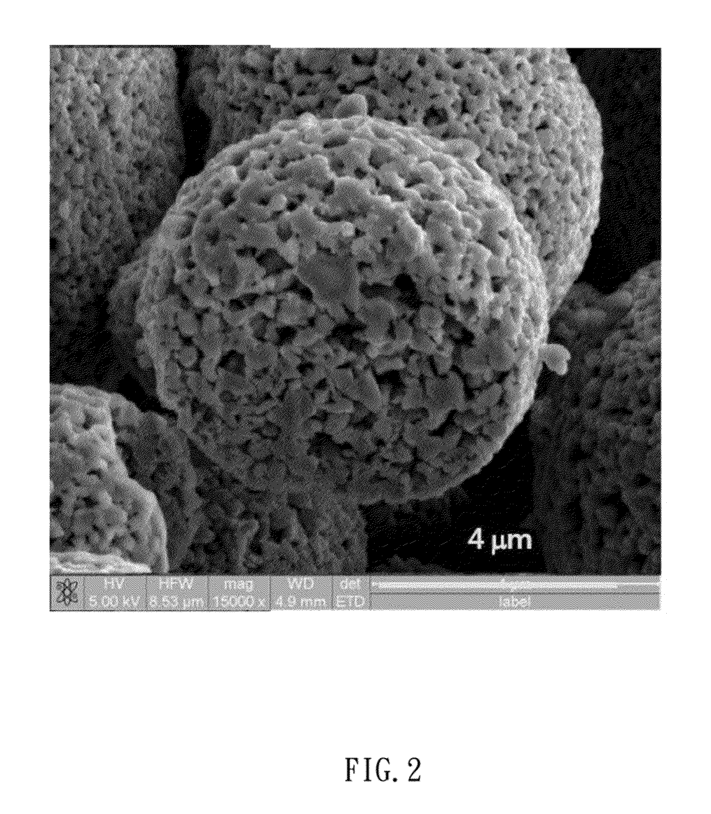

Referring to FIG. 1, there is shown a scheme of illustrating a method of the present invention. The method for preparing a porous lithium phosphate metal salt as shown in FIG. 1, comprising the steps of: providing starting materials, which comprise a phosphate-containing precursor, a lithium-containing precursor, a metal source, and a carbon source; grinding the starting materials at room temperature to obtain a mixture; spray-granulating the mixture to form a granular mixture; and sintering the granular mixture to obtain a porous lithium phosphate metal salt (as shown in FIG. 2). Then, the formed porous lithium phosphate metal salt can be selected with a predetermined size and packaged to be applied to subsequent processes.

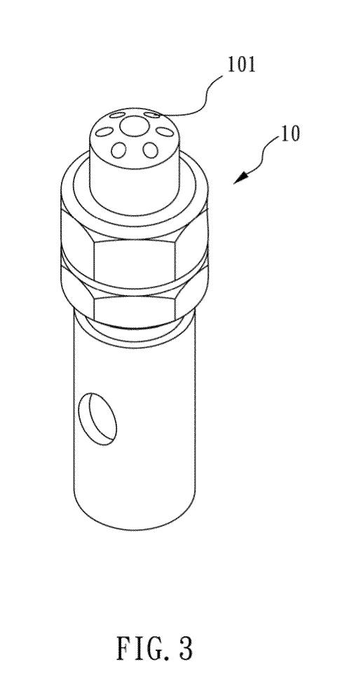

The said spray granulation process is performed by using a spray granulation device having a plurality of spray nozzles. Referring to FIG. 3, a spray nozzle (10) of the spray granulation device is shown. As shown in FIG. 3, the spray nozzle (10) has 6 sub-nozzles (101). There are 6 sub-nozzles (101) represented in FIG. 3 that is used as an example. However, the present invention is not limited to the number of sub-nouzzles of the spray nozzle.

### Embodiment 1

(NH₄)₂HPO₄, Li₂CO₃, and FeC₂O₄ are mixed in a molar ratio of 1:0.5:1, followed by adding vitamin C (about 10 mole %) thereto and performing a grinding process at room temperature to form a mixture. Subsequently, the mixture is converted into a granular mixture by using a spray granulation device having 10 spray nozzles according to the present invention, wherein the flow rate of the spray granulation device is 0.3 L/min, the air flow rate is 120 m³/min, and the nozzle pressure is 8 kg/cm². Meanwhile, the temperature of hot air introduced into the spray granulation device is 230° C., and the outlet temperature of the spray granulation device is 110° C. Next, the formed granular mixture is sintered at 650° C. under an N₂ atmosphere for 10 hours, and porous LiFePO₄ particles are obtained. Finally, the porous LiFePO₄ particles are observed with a scanning electron microscope (SEM), and LiFePO₄ with porous structure of this embodiment is confirmed. In addition, the crystal structure of the obtained porous LiFePO₄ particles according to this embodiment is determined with an X-ray diffraction microscope (XRD). The result shows that the LiFePO₄ phase has a purity of 99.5% or more.

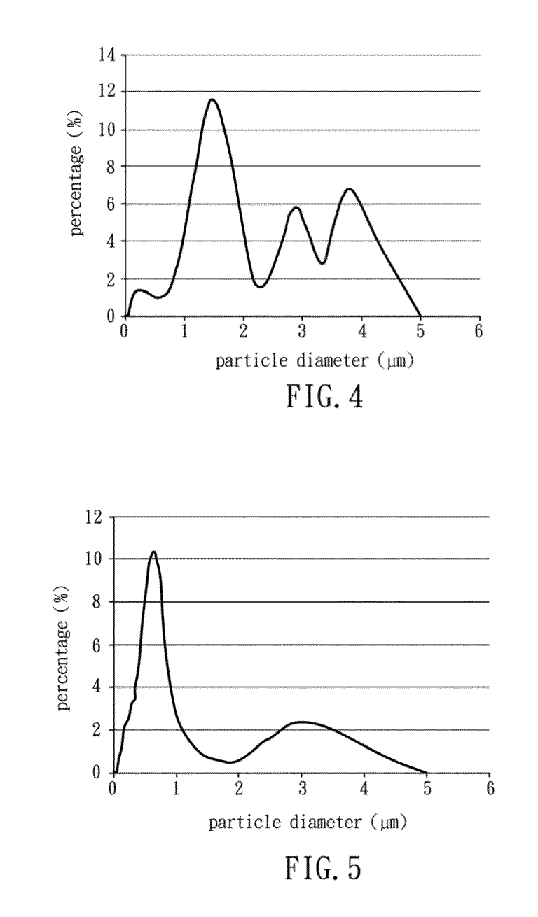

Furthermore, the porous LiFePO₄ particles are examined using a laser scattering particle size distribution analyzer to obtain a multi-Gaussian distribution diagram as shown in FIG. 4, wherein the particle size distribution of the porous LiFePO₄ is multi-Gaussian distribution. The multi-Gaussian distribution of the porous LiFePO₄ particles is analyzed by semi-quantitative analysis. After calculation, the particle size of around 0.3 μm is about 4.5%, the particle size of around 1.5 μm is about 45.6%, the particle size of around 2.9 μm is about 17.9%, and the particle size of around 3.8 μm is about 32.0%. In addition, the porosity of the porous LiFePO₄ particles of this embodiment is 65%.

In this embodiment, (NH₄)₂HPO₄ is used as a phosphate-containing precursor; Li₂CO₃ is used as a lithium-containing precursor; FeC₂O₄ is used as a Fe source; and vitamin C is a carbon source. However, in the present invention according to different requirements, the phosphate-containing precursor can also be at least one selected from the group consisting of H₃PO₄, and NH₄H₂PO₄; the lithium-containing precursor can also be at least one selected from the group consisting of LiOH, and LiCl; the Fe source can also be at least one selected from the group consisting of Fe(NO₃)₃, Fe₂O₃, FePO₄, Fe₂(SO₄)₃, and Fe powders; and the carbon source can also be at least one selected from the group consisting of sugar, citric acid, polyethylene (PE), polypropylene, benzene ring-containing polymer, and linear hydrocarbon.

### Embodiment 2

(NH₄)₂HPO₄, Li₂CO₃, and MnSO₄ are mixed in a molar ratio of 1:0.5:1, followed by adding vitamin C (about 10 mole %) thereto and performing a grinding process at room temperature to form a mixture. Subsequently, the mixture is converted into a granular mixture by using a spray granulation device having 10 spray nozzles according to the present invention, wherein the flow rate of the spray granulation device is 0.3 L/min, the air flow rate is 120 m³/min, and the nozzle pressure is 8 kg/cm². Meanwhile, the temperature of hot air introduced into the spray granulation device is 230° C., and the outlet temperature of the spray granulation device is 110° C. Next, the formed granular mixture is sintered at 650° C. under an N₂ atmosphere for 10 hours, and porous LiMnPO₄ particles are obtained. Finally, the porous LiMnPO₄ particles are observed with a scanning electron microscope (SEM), and LiMnPO₄ with porous structure of this embodiment is confirmed.

Furthermore, the porous LiMnPO₄ particles are examined using a laser scattering particle size distribution analyzer to obtain a multi-Gaussian distribution diagram as shown in FIG. 5, wherein the particle size distribution of the porous LiMnPO₄ particles is multi-Gaussian distribution. The multi-Gaussian distribution of the porous LiMnPO₄ particles is analyzed by semi-quantitative analysis. After calculation, the particle size of around 1.4 μm is about 65.2%, and the particle size of around 3 μm is about 34.8%. In addition, the porosity of the porous LiMnPO₄ particles of this embodiment is 70%.

In this embodiment, (NH₄)₂HPO₄ is used as a phosphate-containing precursor; Li₂CO₃ is used as a lithium-containing precursor; MnSO₄ is used as a Mn source; and vitamin C is a carbon source. However, in the present invention according to different requirements, the phosphate-containing precursor can also be at least one selected from the group consisting of H₃PO₄, and NH₄H₂PO₄; the lithium-containing precursor can also be at least one selected from the group consisting of LiOH, and LiCl; the Mn source can also be at least one selected from the group consisting of Mn(NO₃)₂, Mn(CH₃COO)₂, MnCO₃, MnCl₂, MnO, MnO₂, and Mn₂O₃; and the carbon source can also be at least one selected from the group consisting of sugar, citric acid, polyethylene (PE), polypropylene, benzene ring-containing polymer, and linear hydrocarbon.

### Embodiment 3

(NH₄)₂HPO₄, Li₂CO₃, FeC₂O₄ and MnSO₄ are mixed in a molar ratio of 1:0.5:0.5:0.5, following by adding vitamin C (about 10 mole %) thereto and performing a grinding process at room temperature to form a mixture. Subsequently, the mixture is converted into a granular mixture by using a spray granulation device having 10 spray nozzles according to the present invention, wherein the flow rate of the spray granulation device is 0.3 L/min, the air flow rate is 120 m³/min, and the nozzle pressure is 8 kg/cm². Meanwhile, the temperature of hot air introduced into the spray granulation device is 230° C., and the outlet temperature of the spray granulation device is 110° C. Next, the formed granular mixture is sintered at 650° C. under a N₂ atmosphere for 10 hours, and porous LiFe_{0.5}Mn_{0.5}PO₄ particles are obtained. Finally, the porous LiFe_{0.5}Mn_{0.5}PO₄ particles are observed with a scanning electron microscope (SEM), and LiFe_{0.5}Mn_{0.5}PO₄ with porous structure of this embodiment is confirmed.

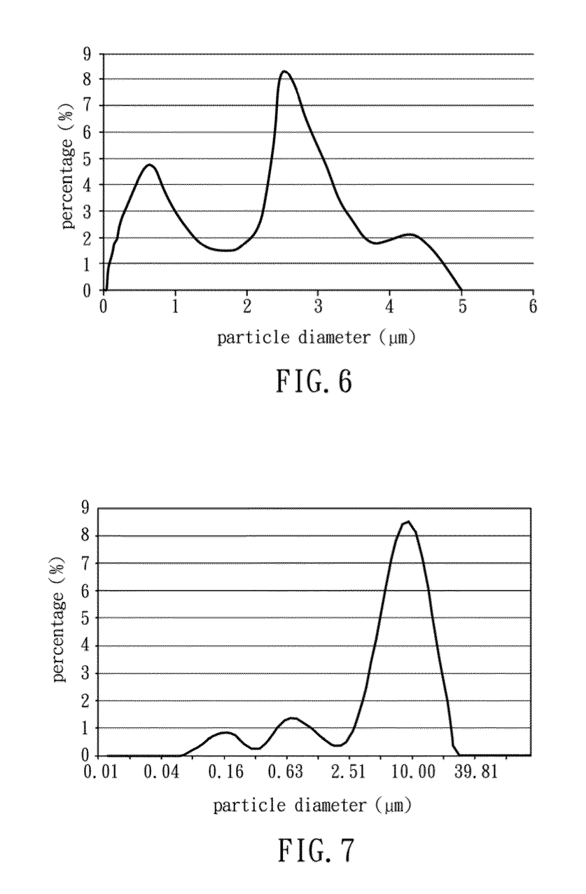

Furthermore, the porous LiFe_{0.5}Mn_{0.5}PO₄ particles are examined using a laser scattering particle size distribution analyzer to obtain a multi-Gaussian distribution diagram as shown in FIG. 6, wherein the particle size distribution of the porous LiFe_{0.5}Mn_{0.5}PO₄ particles is multi-Gaussian distribution. The multi-Gaussian distribution of the porous LiFe_{0.5}Mn_{0.5}PO₄ particles is analyzed by semi-quantitative analysis. After calculation, the particle size of around 0.7 μm is about 30.8%, the particle size of around 2.6 μm is about 58.1%, and the particle size of around 4.3 μm is about 11.1%. In addition, the porosity of the porous LiFe_{0.5}Mn_{0.5}PO₄ particles of this embodiment is 65%.

In this embodiment, (NH₄)₂HPO₄ is used as a phosphate-containing precursor; Li₂CO₃ is used as a lithium-containing precursor; FeC₂O₄ is used as a Fe source; MnSO₄ is used as a Mn source; and vitamin C is a carbon source. However, in the present invention according to different requirements, the phosphate-containing precursor can also be at least one selected from the group consisting of H₃PO₄, and NH₄H₂PO₄; the lithium-containing precursor can also be at least one selected from the group consisting of LiOH, and LiCl; the Fe source can also be at least one selected from the group consisting of Fe(NO₃)₃, Fe₂O₃, FePO₄, Fe₂(SO₄)₃, and Fe powders; the Mn source can also be at least one selected from the group consisting of Mn(NO₃)₂, Mn(CH₃COO)₂, MnCO₃, MnCl₂, MnO, MnO₂, and Mn₂O₃; and the carbon source can also be at least one selected from the group consisting of sugar, citric acid, polyethylene (PE), polypropylene, benzene ring-containing polymer, and linear hydrocarbon. In addition, according to different ratios of the Fe source to the Mn source, a porous lithium iron manganese phosphate represented as LiFe₁₋ₓMnₓPO₄ can be formed, wherein x is from 0.2 to 0.8.

### COMPARATIVE EXAMPLE 1

(NH₄)₂HPO₄, Li₂CO₃, and FeC₂O₄ are mixed in a molar ratio of 1:0.5:1, followed by adding vitamin C (about 10 mole %) thereto and performing a grinding process at room temperature to form a mixture. Subsequently, the mixture is converted into a granular mixture by using a conventional granulation device having a single spray nozzle. Next, the formed granular mixture is sintered at 650° C. under a N₂ atmosphere for 10 hours, and LiFePO₄ particles are obtained. Finally, the LiFePO₄ particles are observed with a scanning electron microscope (SEM).

The formed LiFePO₄ particles are examined using a laser scattering particle size distribution analyzer to obtain a Gaussian distribution diagram as shown in FIG. 7, wherein about 77% of the LiFePO₄ particle sizes are mainly distributed within 2.51 to 32.35 μm, and the LiFePO₄ particles have non-porous structure.

### COMPARATIVE EXAMPLE 2

(NH₄)₂HPO₄, Li₂CO₃, and MnSO₄ are mixed in a molar ratio of 1:0.5:1, followed by adding vitamin C (about 10 mole %) thereto and performing a grinding process at room temperature to form a mixture. Subsequently, the mixture is converted to form a granular mixture by using a conventional granulation device having a single spray nozzle. Next, the formed granular mixture is sintered at 650° C. under a N₂ atmosphere for 10 hours, and LiMnPO₄ particles are obtained. Finally, the LiMnPO₄ particles are observed with a scanning electron microscope (SEM).

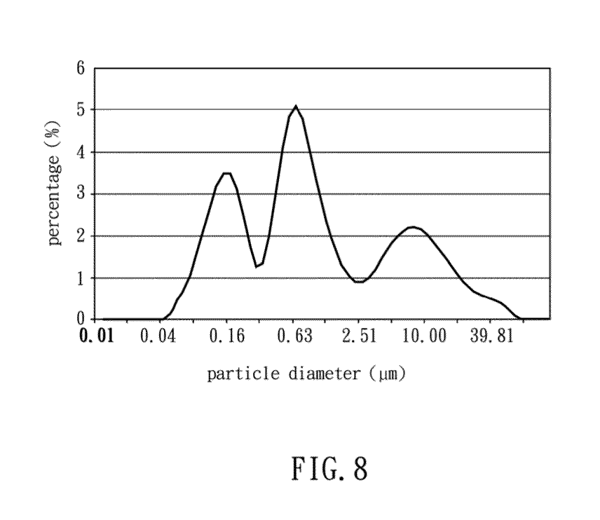

The formed LiMnPO₄ particles are examined using a laser scattering particle size distribution analyzer to obtain a Gaussian distribution diagram as shown in FIG. 8, wherein the LiMnPO₄ particle size distribution is mainly in three regions. The LiMnPO₄ particle size of around 0.16 μm is about 33%, the LiMnPO₄ particle size of around 0.63 μm is about 46%, and the LiMnPO₄ particle size of around 9.8 μm is about 21%. In addition, the LiMnPO₄ particles have non-porous structure.

According to the results as described above, D90 of the lithium phosphate metal salts formed from Comparative Example 1 and Comparative Example 2 are more than 5 μm (as shown in FIG. 7 and FIG. 8). However, D90 of the porous lithium phosphate metal salts of Embodiments 1, 2, and 3 can be controlled within 5 μm by a spray granulation process. Therefore, in the method for preparing the porous lithium phosphate metal salt of the present invention, the porous lithium phosphate metal salts (D90≦5 μm) can be obtained by using specific designs of spray nozzles and experimental conditions.

In conclusion, the lithium phosphate metal salts formed by the method of the present invention have porous structure, and nano, submicro, or micro grain size, so as to increase the charge/discharge cycles of lithium secondary batteries and the insert/extricate rate of Li ions in the porous structure. Hence, the methods for preparing a porous lithium phosphate metal salt of the present invention have many advantages such as simple processes, short time for manufacturing, and low cost. The porous lithium phosphate metal salt of the present invention can be applied to manufacturing lithium secondary batteries to reduce the production cost of batteries.

Although the present invention has been explained in relation to its preferred embodiment, it is to be understood that many other possible modifications and variations can be made without departing from the spirit and scope of the invention as hereinafter claimed.

1. A method for preparing a porous lithium phosphate metal salt, comprising the steps of:
(A) providing starting materials, which comprises a phosphate-containing precursor, a lithium-containing precursor, a metal source, and a carbon source;
(B) grinding the starting materials at room temperature to obtain a mixture;
(C) spray-granulating the mixture to form a granular mixture; and
(D) sintering the granular mixture to obtain a porous lithium phosphate metal salt represented by the following formula (I):
LiAₓB₁₋ₓPO₄ (I);
wherein x is from 0 to 1;
A is a IIIA metal element selected from Al, Ga, or In, or a transition metal selected from Fe, Co, Ni, Mn, or V; and
B is a IIIA metal element selected from Al, Ga, or In, or a transition metal selected from Fe, Co, Ni, Mn, or V.

2. The method as claimed in claim 1, wherein the porous lithium phosphate metal salt has an olivine structure.

3. The method as claimed in claim 1, wherein the phosphate-containing precursor is at least one selected from the group consisting of H₃PO₄, (NH₄)₂HPO₄, and NH₄H₂PO₄.

4. The method as claimed in claim 1, wherein the lithium-containing precursor is at least one selected from the group consisting of Li₂CO₃, LiOH, and LiCl.

5. The method as claimed in claim 1, wherein the metal source is at least one selected from the group consisting of Fe source, Mn source, and Co source.

6. The method as claimed in claim 5, wherein the Fe source is at least one selected from the group consisting of FeC₂O₄, Fe(NO₃)₃, Fe₂O₃, FePO₄, Fe₂(SO₄)₃, and Fe powders.

7. The method as claimed in claim 5, wherein the Mn source is at least one selected from the group consisting of MnSO₄, Mn(NO₃)₂, Mn(CH₃COO)₂, MnCO₃, MnCl₂, MnO, MnO₂, and Mn₂O₃.

8. The method as claimed in claim 1, wherein the carbon source is at least one selected from the group consisting of sugar, vitamin C, citric acid, polyethylene (PE), polypropylene, benzene ring-containing polymer, and linear hydrocarbon.

9. The method as claimed in claim 1, wherein the step (C) is performed by using a spray granulation device having a plurality of spray nozzles, each of which has a plurality of sub-nozzles.

10. The method as claimed in claim 9, wherein the type of the spray nozzle in the spray granulation device is rotary type, pressure type, two-fluid type, or combinations thereof.

11. The method as claimed in claim 9, wherein the number of the spray nozzles in the spray granulation device is 8 to 16.

12. The method as claimed in claim 9, wherein the spray granulation device is set at a flow rate from 0.3 L/min to 1.5 L/min.

13. The method as claimed in claim 9, wherein the spray granulation device is set at an air flow rate from 50 to 150 m³/min.

14. The method as claimed in claim 9, wherein the spray granulation device is set at a nozzle pressure from 2 to 8 kg/cm².

15. The method as claimed in claim 9, wherein hot air introduced into the spray granulation device has a temperature from 180 to 240° C.

16. The method as claimed in claim 9, wherein the spray granulation device is set at an outlet temperature from 90 to 120° C.

17. The method as claimed in claim 1, wherein the step (D) is performed under an N₂ atmosphere.

18. The method as claimed in claim 1, wherein the step (D) is performed at a temperature from 650 to 850° C.

19. The method as claimed in claim 1, wherein the step (D) is performed for 3 to 10 hours.

20. A porous lithium phosphate metal salt in a granular shape, which is a composition represented by the following formula (I):
LiAₓB₁₋ₓPO₄ (I);
wherein x is from 0 to 1;
A is a IIIA metal element selected from Al, Ga, or In, or a transition metal selected from Fe, Co, Ni, Mn, or V;
B is a IIIA metal element selected from Al, Ga, or In, or a transition metal selected from Fe, Co, Ni, Mn, or V; and
the porous lithium phosphate metal salt is prepared by the method as claimed in claim 1.

21. The porous lithium phosphate metal salt as claimed in claim 20, wherein the porous lithium phosphate metal salt has a mean particle diameter from 0.5 to 3 μm.

22. The porous lithium phosphate metal salt as claimed in claim 20, wherein the porous lithium phosphate metal salt has a pore size from 0.2 to 1 μm.

23. The porous lithium phosphate metal salt as claimed in claim 20, wherein t the porous lithium phosphate metal salt has a porosity from 10 to 80%.

24. The porous lithium phosphate metal salt as claimed in claim 20, wherein the porous lithium phosphate metal salt has a multi-Gaussian particle size distribution.
